(19) United States
(12) Patent Application Publication
(10) Pub. No.: US 2017/0220569 A1
(43) Pub. Date: Aug. 3, 2017

(54) METHOD AND SYSTEM FOR CONSTRUCTING PLACE DATABASE USING CROWDSOURCING

(71) Applicant: Electronics and Telecommunications Research Institute, Daejeon (KR)

(72) Inventors: Joonmyun CHO, Daejeon (KR); Youngho SUH, Daejeon (KR); Seong Ho LEE, Daejeon (KR); Yoon-Seop CHANG, Daejeon (KR)

(21) Appl. No.: 15/415,192

(22) Filed: Jan. 25, 2017

(30) Foreign Application Priority Data
Feb. 3, 2016 (KR) 10-2016-0013606

(51) Int. Cl. G06F 17/30; H04W 4/02

(52) U.S. Cl. CPC G06F 17/3028; H04W 4/02; G06F 17/30241; G06F 17/30268

(57) ABSTRACT

Provided is a method for constructing a place database using data transmitted from a mobile device to a server. The method may include receiving an image of a target shot by the mobile device and coordinates of an image shooting place of the target, providing a recommendation list of a section to which the received coordinates belong, receiving, from the mobile device, a name of the target selected or not selected from the recommendation list, receiving keywords related to the target for constructing or updating the database, and constructing or updating the database on the basis of the image and the keywords.

### CROSS-REFERENCE TO RELATED APPLICATIONS

This U.S. non-provisional patent application claims priority under 35 U.S.C. §119 of Korean Patent Application No. 10-2016-0013606, filed on Feb. 3, 2016, the entire contents of which are hereby incorporated by reference.

### BACKGROUND

The present disclosure herein relates to construction of a database, and more particularly, to a method for constructing a place database using crowdsourcing.

With the development of communication systems using the Internet and the spread of smartphones, various search services for providing data to meet users' requests are being actively developed or provided. However, a database should be constructed in advance to provide such services.

However, even if a database is constructed by collecting a large amount of data, it is difficult to provide customized data satisfying a user's request. For example, it is assumed that a place where a way station exists in a pine forest at the seaside is sought to shoot a scene of parting of lovers to produce a movie or a soap opera. If a service which supports a location hunting function is provided, a user may input keywords such as “seaside”, “pine forest”, “way station”, or the like to search for a place, or may directly input a specific famous place name to search for a place.

Therefore, it is very import for a provider of such a search service to construct a database for providing information about a place or a target satisfying a user's request.

### SUMMARY

The present disclosure provides a method for constructing a place database using crowdsourcing.

An embodiment of the inventive concept provides a method for constructing a place database using data transmitted from a mobile device to a server, the method including: receiving an image of a target shot by the mobile device and coordinates of an image shooting place of the target; providing a recommendation list of a section to which the received coordinates belong; receiving, from the mobile device, a name of the target selected or not selected from the recommendation list; receiving keywords related to the target for constructing or updating the database; and constructing or updating the database on the basis of the image and the keywords.

In an embodiment, the data may be classified and stored in the database according to a section to which coordinates of the target or the received coordinates belong. Furthermore, the received coordinates may be based on latitude and longitude, may be measured by a GPS module provided to the mobile device, and may be tagged to the image when the image of the target is shot. Alternatively, the name of the target received from the mobile device may be selected by a user of the mobile device from the recommendation list or input by the user.

In an embodiment, the receiving the keywords may include: transmitting tags for constructing or updating the database; and receiving keywords input by a user of the mobile device, the keywords corresponding to the tags respectively.

In an embodiment, the method may further include: determining whether the name of the target received from the mobile device is selected from the recommendation list; and determining whether the received coordinates belong to an existing section present in the database.

In an embodiment, in the case where the name of the target received from the mobile device is selected from the recommendation list and the received coordinates belong to the existing section present in the database, information about the target stored in the database may be updated.

In an embodiment, in the case where the name of the target received from the mobile device is selected from the recommendation list and the received coordinates do not belong to the existing section present in the database, extension of an area of the existing section may be performed, and information about the target stored in the database may be updated.

In an embodiment, the extension of the area of the existing section may be performed so that the existing section and a closed surface formed by the received coordinates are included within an area of an extended section.

In an embodiment, in the case where the name of the target received from the mobile device has not been selected from the recommendation list and the received coordinates belong to the existing section present in the database, information about the target belonging to the existing section may be newly generated.

In an embodiment, in the case where the name of the target received from the mobile device has not been selected from the recommendation list and the received coordinates do not belong to the existing section present in the database, a new section including the received coordinates and information about the target belonging to the new section may be newly generated.

In an embodiment, the new section may have an area within a closed surface formed by coordinates of at least three image shooting places of the target.

In an embodiment, the new section may have an area within a circle centered at the received coordinates and having a radius equal to a distance between the received coordinates and coordinates of the target.

In an embodiment, the distance between the received coordinates and the coordinates of the target may be measured using an auto-focusing function performed using an infrared sensor installed in the mobile device.

In an embodiment of the inventive concept, a server includes: a crowdsourcing module configured to receive an image of a target shot by a mobile device and coordinates of an image shooting place of the target, receive a name of the target selected or not selected from a recommendation list of a section to which the received coordinates belong, and receive keywords related to the target; and a database in which the image and the keywords are classified and stored according to a section to which coordinates of the target or the received coordinate belong.

In an embodiment, the crowdsourcing module may update information about the target stored in the database in the case where the name of the target received from the mobile device is selected from the recommendation list and the received coordinates belong to an existing section present in the database.

In an embodiment, the crowdsourcing module may extend an area of an existing section present in the database and update information about the target stored in the database in the case where the name of the target received from the mobile device is selected from the recommendation list and the received coordinates do not belong to the existing section.

In an embodiment, the crowdsourcing module may newly generate information about the target belonging to an existing section present in the database in the case where the name of the target received from the mobile device has not been selected from the recommendation list and the received coordinates belong to the existing section.

In an embodiment, the crowdsourcing module may newly generate a new section including the received coordinates and information about the target belonging to the new section in the case where the name of the target received from the mobile device has not been selected from the recommendation list and the received coordinates do not belong to an existing section present in the database.

In an embodiment, the server may further include: a memory configured to load the crowdsourcing module; a processor configured to run the crowdsourcing module loaded on the memory; and a network adaptor configured to communicate with the mobile device via a network.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a diagram exemplarily illustrating a system for constructing a place database according to an embodiment of the inventive concept;

FIG. 2 is a flowchart illustrating operations performed between a mobile device and a server to construct a place database according to an embodiment of the inventive concept;

FIG. 3 is a block diagram exemplarily illustrating a data structure of a place database constructed according to an embodiment of the inventive concept;

FIG. 4 is a diagram exemplarily illustrating the concept of a section;

FIG. 5 is a diagram illustrating an example in which operations S120 to S140 of FIG. 2 are implemented as a user interface;

FIG. 6 is a diagram illustrating an example in which operations S150 and S160 of FIG. 2 are implemented as a user interface;

FIGS. 7 and 8 are diagrams exemplarily illustrating a case in which section extension occurs according to an embodiment of the inventive concept;

FIGS. 9 to 12 are diagrams exemplarily illustrating a case in which new section generation occurs according to an embodiment of the inventive concept;

FIGS. 13 to 15 are diagrams exemplarily illustrating a case in which new section generation occurs according to an embodiment of the inventive concept;

FIG. 16 is a flowchart illustrating a method for constructing a place database according to an embodiment of the inventive concept; and

FIG. 17 is a diagram illustrating an example of implementation of a server for constructing a place database according to an embodiment of the inventive concept.

### DETAILED DESCRIPTION

It should be understood that the above-described background and the following detailed description are exemplarily provided for describing the claimed invention. Reference signs are presented in embodiments of the inventive concept, and examples thereof are illustrated in the accompanying drawings. In any possible case, the same reference numerals are used in the description and the drawings to refer to the same or similar elements.

It will be understood that when an element or a layer is referred to as being “connected to”, “coupled to”, or “adjacent to” another element or layer, it can be directly connected or coupled to or adjacent to the other element or layer, or it can be indirectly connected or coupled to or adjacent to the other element or layer with an intervening element or layer therebetween. As used herein, the term “and/or” includes any and all combinations of one or more of the associated listed items.

It will be understood that, although the terms “first”, “second”, etc. may be used herein to describe various elements, these elements should not be limited by these terms. These terms are only used to distinguish one element from other elements. Thus, a first element, section, or layer discussed below could be termed a second element, section, or layer without departing from the teachings of the present invention.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, steps, operations, elements, and/or components, but do not preclude the presence or addition of one or more other features, steps, operations, elements, components, and/or groups thereof.

Exemplary embodiments of the inventive concept will be described in detail with reference to the accompanying drawings so that those skilled in the art easily implement the inventive concept.

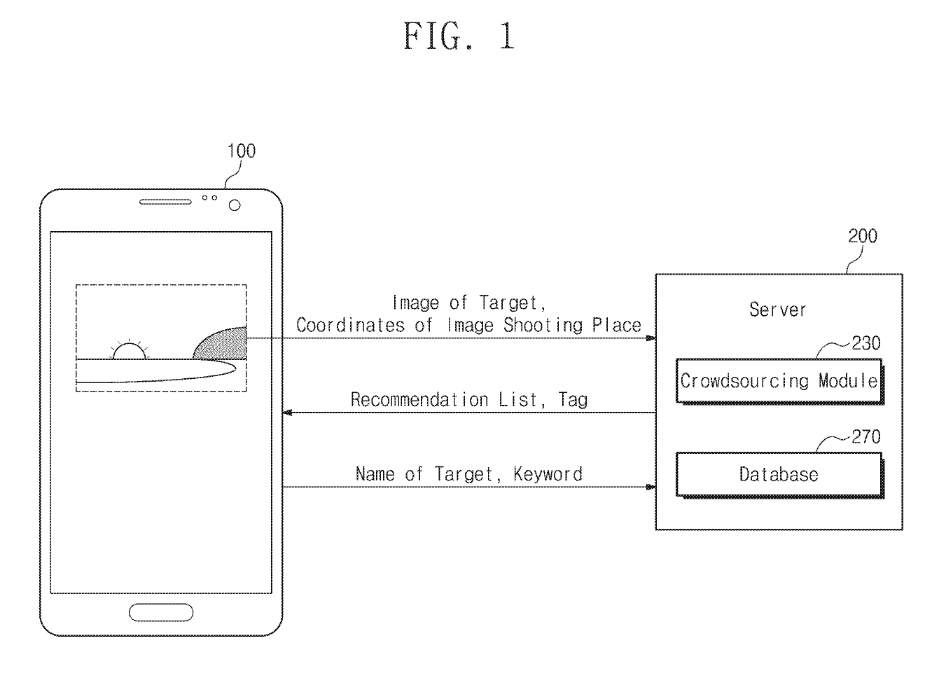

FIG. 1 is a diagram exemplarily illustrating a system for constructing a place database according to an embodiment of the inventive concept. Referring to FIG. 1, the system may include a mobile device 100 and a server 200.

The mobile device 100 may represent a device configured to shoot an image of a target and transmit coordinates of an image shooting place to the server 200. When the image of the target (e.g., a natural object, an artifact, etc.) is shot by a user, the mobile device 100 may tag the image with the coordinates of the image shooting place. The coordinates of the image shooting place may be measured using Global Positioning System (GPS). However, an embodiment of the inventive concept is not limited thereto, and thus the coordinates of the image shooting place may be measured using various navigation standards such as Global Navigation Satellite System (GLONASS), Compass, Galileo, and Quasi-Zenith Satellite System

(QZSS). The coordinates of the image shooting place may include latitude and longitude. For example, the mobile device 100 may be a smartphone, a tablet PC, or a digital camera.

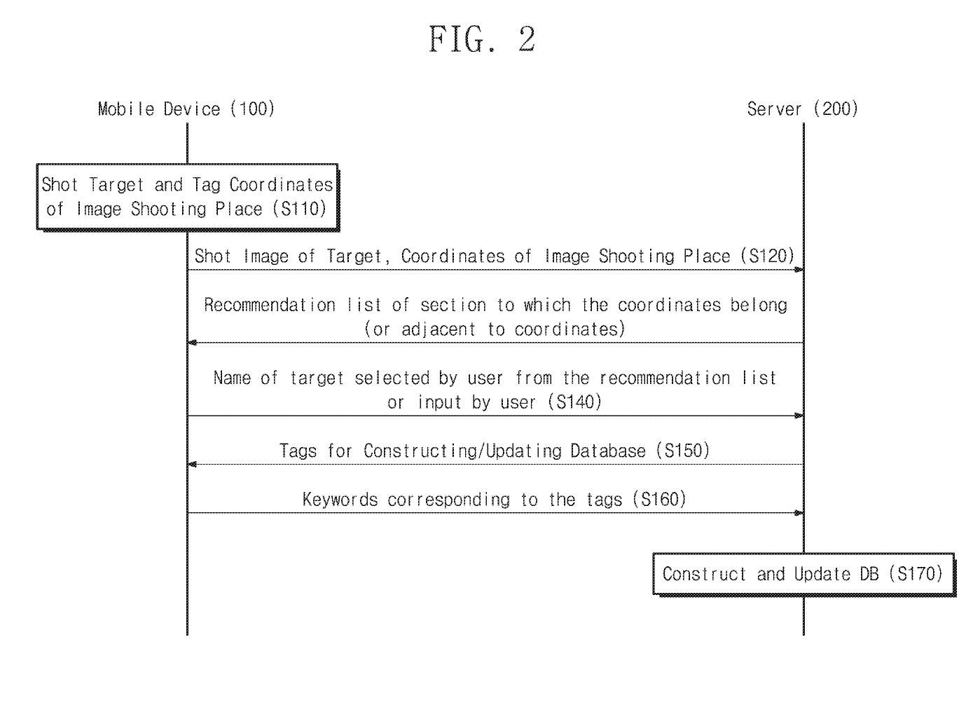

The server 200 may include a crowdsourcing module 230 and a database 270. The crowdsourcing module 230 may be configured to construct or update the database 270 on the basis of the image of the target and information on the target received from the mobile device 100. For example, the crowdsourcing module 230 may provide various recommendation lists and tags to the user of the mobile device 100 according to the coordinates of the image shooting place received from the mobile device 100. Thereafter, the server 200 may receive a target name and a keyword selected from the recommendation lists by the user of the mobile device 100. The server 200 may construct or update the database 270 on the basis of the received keyword and the image of the target. Operation of the crowdsourcing module 230 is described below in more detail with reference to FIG. 2 and the following figures.

According to an embodiment of the inventive concept, a database may be constructed or updated using crowdsourcing. In particular, when an image of a target is shot using the mobile device 100, location information of an image shooting place may be tagged to an image file of the target, and the crowdsourcing module 230 may systematize the database 270 using the tagged location information. As a result, various images of the target and various keywords about the target may be collected and systematized, so that excellent services may be provided to other users.

FIG. 2 is a flowchart illustrating operations performed between the mobile device 100 and the server 200 to construct a place database according to an embodiment of the inventive concept.

In operation S110, an image of a target may be shot. The image of the target may be shot using a mobile device (e.g., a smartphone, a tablet PC, a digital camera, or the like) provided with various means for measuring coordinates of an image shooting place, such as a GPS module. The coordinates of the image shooting place may be measured at the same time as shooting the image, and measured coordinates may be tagged to an image file of the target.

In operation S120, the shot image of the target may be transmitted to the server 200. Since the coordinates of the image shooting place have been tagged to the image file of the target, the coordinates of the image shooting place may also be transmitted to the server 200.

In operation S130, the server 200 may provide, to the user of the mobile device 100, a list of recommendations on a section to which the coordinates of the image shooting place belong or a section adjacent to the coordinates of the image shooting place. Here, the section may represent a geographical area defined by a closed surface, and at least one target may belong to each section. That is, in the database, data on targets may be classified and stored according to sections to which the targets geographically belong. The recommendation list provided by the server 200 may be based on data stored in the database 270. For example, the recommendation list may include natural objects, artifacts, or place names (e.g., N Seoul Tower, Gyeongbokgung Palace, Insa-dong, etc.) belonging to the section to which the coordinates of the image shooting place belong or the section adjacent to the coordinates of the image shooting place.

In operation S140, a target name input or selected by the user of the mobile device 100 from the recommendation list transmitted to the mobile device 100 may be received. For example, when a name matched to the image of the target shot by the user of the mobile device 100 exists in the recommendation list transmitted to the mobile device 100, the user of the mobile device 100 may select the name, and the selected name may be transmitted to the server 200. On the contrary, when a name matched to the image of the target shot by the user of the mobile device 100 does not exist in the recommendation list transmitted to the mobile device 100, the user itself of the mobile device 100 may input the name, and the input name may be transmitted to the server 200.

In operation S150, tags may be transmitted to the mobile device 100 to collect keywords required for constructing or updating the database 270. Here, the tags are provided to receive keywords about the image-shot target from the mobile device 100, and may include a plurality of categories. For example, the tags provided by the server 200 may represent items for inducing an input by the user of the mobile device 100, such as background, natural object, artifact, description, etc. That is, once the server 200 transmits the tags such as background, natural object, artifact, description, etc. to the mobile device 100, the user of the mobile device 100 may input keywords (e.g., sea, seaside, famous place to see sunrise, etc.) corresponding to respective tags.

In operation S160, keywords corresponding to the tags transmitted to the mobile device 100 may be received. The received keywords may be used to construct or update a database for the target of which the image has been shot by the user of the mobile device 100. When information related to the target of which the image has been shot by the user of the mobile device 100 is not stored in the database 270, a new database related to the target may be constructed. When information related to the target of which the image has been shot by the user of the mobile device 100 is already stored in the database 270, the database related to the target may be updated.

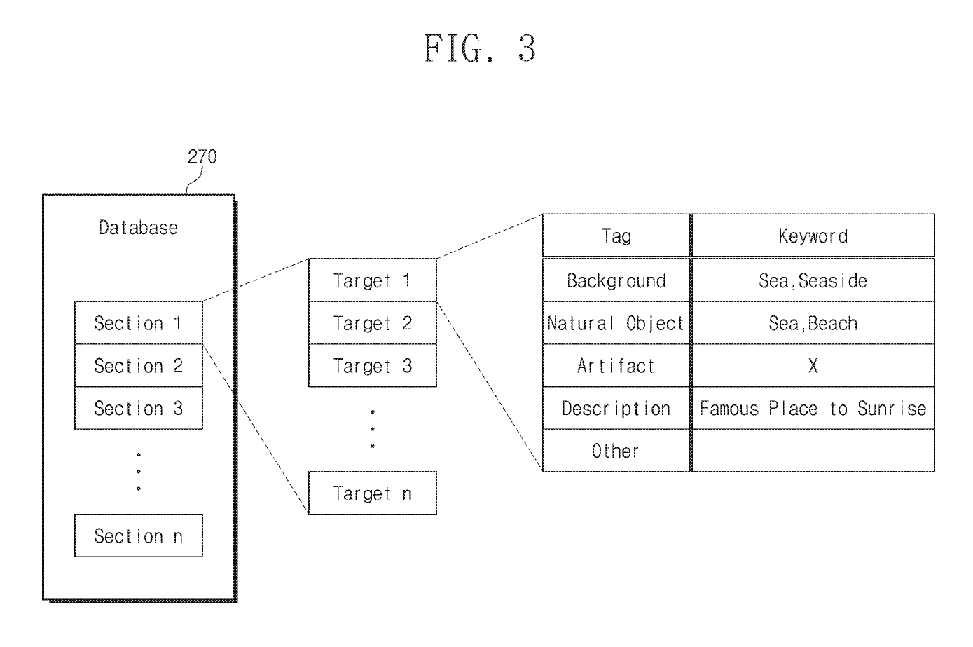

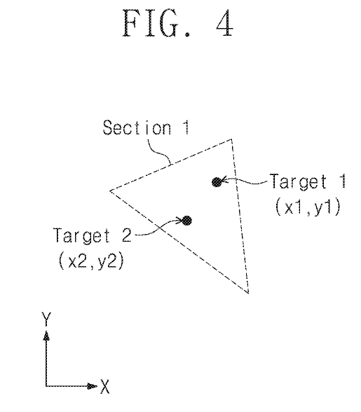

FIG. 3 is a block diagram exemplarily illustrating a data structure of a place database constructed according to an embodiment of the inventive concept. FIG. 4 is a diagram exemplarily illustrating the concept of a section. In FIG. 4, the X-axis denotes longitude, and the Y-axis denotes latitude.

Referring to FIGS. 3 and 4, the data stored in the database 270 may be classified according to a plurality of sections (section 1 to section n). The section is a geographical concept, and may be defined by a plurality of coordinates including latitude and longitude. For example, section 1 illustrated in FIG. 1 is configured with a closed surface formed by three vertices. FIGS. 3 and 4 exemplarily illustrate that target 1 and target 2 belong to section 1. The coordinates of target 1 is (x1, y1), and the coordinates of target 2 is (x2, y2). That is, in the database 270, information on a plurality of targets may be classified and stored according to sections to which the targets belong. For example, pieces of information on target 1 (e.g., keywords and shot images of target 1) and pieces of information on target 2 (e.g., keywords and shot images of target 2) may be classified to belong to section 1.

Referring to FIG. 3, each section may include a plurality of targets. For example, provided that section 1 represents an area including Jung-gu, Seoul City, this case is similar to the case in which a plurality of targets such as Gyeongbokgung Palace, Gwanghwamun Gate, Insa-dong, etc. located in Jung-gu, Seoul City belong to a single section.

Still referring to FIG. 3, information on each target may include a plurality of tags (or keywords). Here, the tags may be transmitted from the server 200 to the mobile device 100, and keywords corresponding to respective tags may be input by the user of the mobile device 100. For example, provided that the user has shot an image of Jeongdongjin by using the mobile device 100, the user who has received the tags from the server 200 inputs keywords such as sea, seaside, beach, famous place to see sunrise, and the like to the mobile device 100.

As described above, since pieces of information on a plurality of targets are classified according to sections to which the targets belong, and a database is updated through participation of users (i.e., crowdsourcing), an excellent search service may be provided.

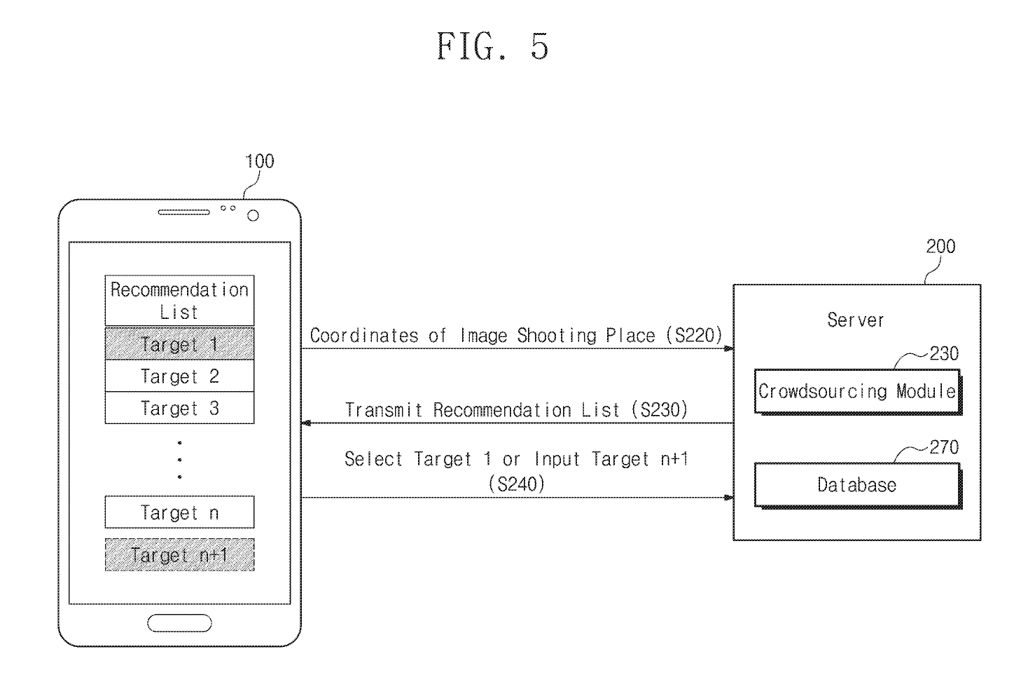

FIG. 5 is a diagram illustrating an example in which operations S120 to S140 of FIG. 2 are implemented as a user interface. When an image of a target is shot by the user of the mobile device 100, the coordinates of an image shooting place are tagged to an image file of the target. Once the coordinates of the image shooting place is transmitted to the server 200 together with the image of the target (S220), the crowdsourcing module 230 of the server 200 may transmit a recommendation list to the mobile device 100 (S230). For example, the recommendation list may include a name of at least one target belonging to a section to which the image shooting place belongs.

For example, it is assumed that the user shoots an image of target 1, and the image of target 1 tagged with the coordinates of the image shooting place is transmitted to the server 200. If a section to which the received coordinates belong exists in the database 270, the crowdsourcing module 230 may transmit, to the mobile device 100, the recommendation list (e.g., names of target 1 to target n) for the section to which the received coordinates belong (S230). In this case, since target 1 is on the recommendation list, the user of the mobile device 100 may select target 1 (S240).

Meanwhile, it is assumed that the user shoots an image of target n+1, and the image of target n+1 tagged with the coordinates of the image shooting place is transmitted to the server 200. If a section to which the received coordinates belong exists in the database 270, the crowdsourcing module 230 may transmit, to the mobile device 100, the recommendation list (e.g., names of target 1 to target n) for the section to which the received coordinates belong (S230). However, in this case, since target n+1 is not on the recommendation list, the user itself of the mobile device 100 may input a name of target n+1 to the mobile device 100, and the name of target n+1 may be transmitted to the crowdsourcing module 230 (S240).

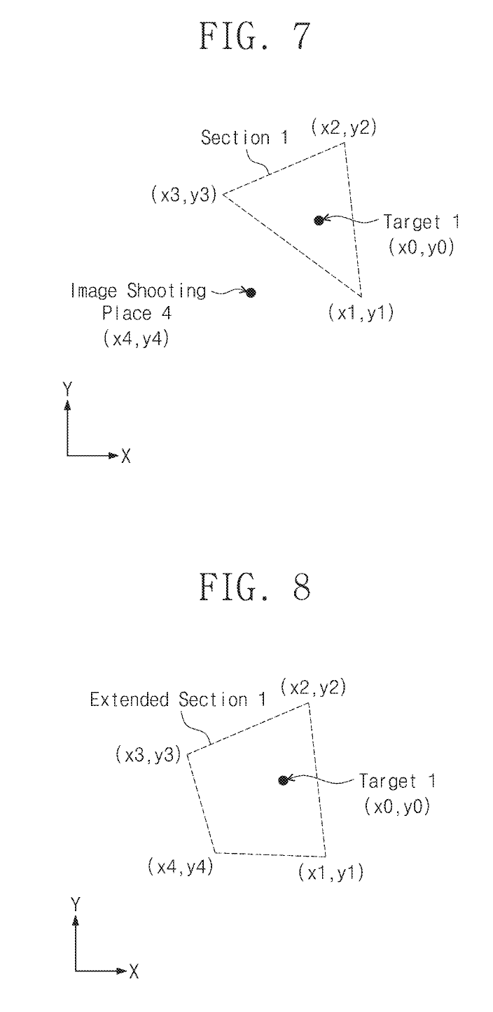

For another example, there may occur a case in which a section to which the coordinates of an image shooting place belong is not stored in the database 270, but the recommendation list provided by the crowdsourcing module 230 includes the name of a target. This case may indicate that the image of the target has been shot outside the section to which the target belongs. In this case, section extension is performed, and this operation is described below in more detail with reference to FIGS. 7 and 8.

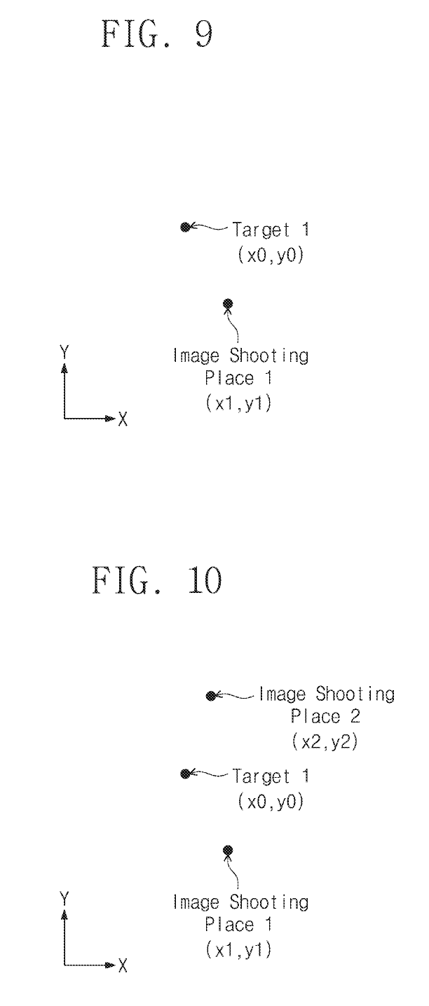

For another example, there may occur a case in which a section to which the coordinates of an image shooting place belong is not stored in the database 270, and the recommendation list provided by the crowdsourcing module 230 does not include the name of a target. This case may indicate that no information about the target is stored in the database. In this case, section generation is performed, and this operation is described below in more detail with reference to FIGS. 9 to 15.

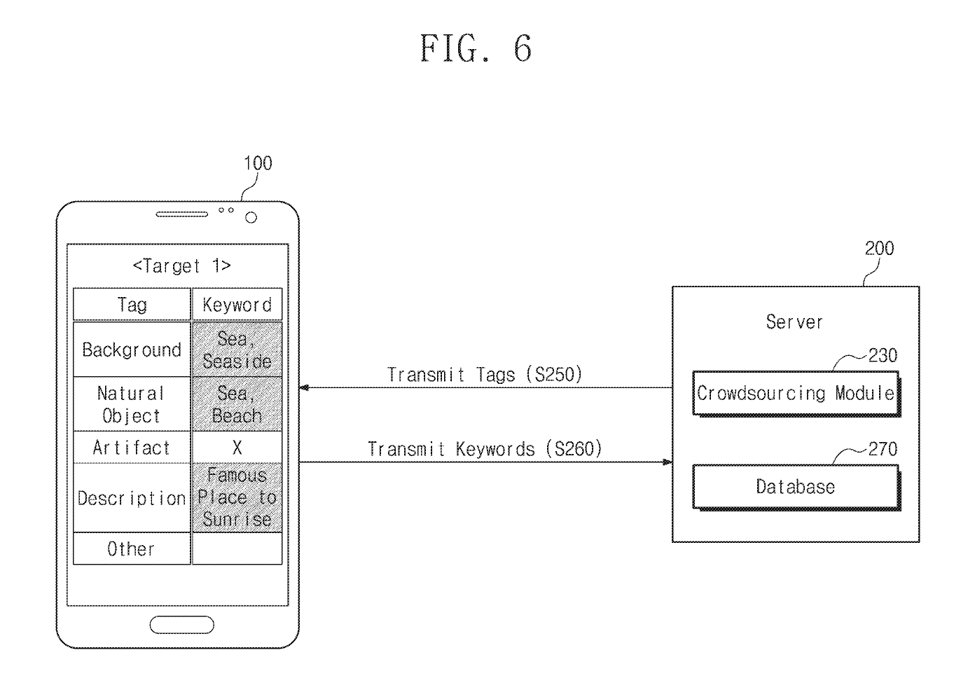

FIG. 6 is a diagram illustrating an example in which operations S150 and S160 of FIG. 2 are implemented as a user interface. After the server 200 receives the name of the target, the server 200 may transmit tags to the mobile device 100 (S250). As illustrated in FIG. 6, the tags may include various categories (e.g., background, natural object, artifact, description, etc.) so as to facilitate a data search by another user. Once the tags are transmitted to the mobile device 100, the mobile device 100 may input keywords corresponding to the tags. For example, as illustrated in FIG. 6, the user may input “sea” and “seaside” as keywords corresponding to the background, and may input “sea” and “beach” as keywords corresponding to the natural object. The keywords input by the user of the mobile device 100 may be transmitted to the server 200 (S260). The tags or the keywords illustrated in FIG. 6 are merely exemplary and are intended to assist with an understanding, and thus an embodiment of the inventive concept is not limited thereto.

FIGS. 7 and 8 are diagrams exemplarily illustrating a case in which section extension occurs according to an embodiment of the inventive concept. As described above, in the case where a section to which the coordinates of an image shooting place belong is not stored in the database 270, but the recommendation list provided by the crowdsourcing module 230 includes the name of a target, the section extension may be performed.

Referring to FIG. 7, section 1 is assumed as an area within a closed surface formed by coordinates (x1, y1), (x2, y2), and (x3, y3). Furthermore, it is assumed that target 1 is located at coordinates (x0, y0) within section 1. In FIG. 7, the X-axis denotes longitude, and the Y-axis denotes latitude.

When the user of the mobile device 100 shoots the image of target 1 within the area of section 1, the extension of section 1 is not required. However, when the user of the mobile device 100 shoots the image of target 1 outside the area of section 1 (i.e., at image shooting place 4), the extension of section 1 is required. This is because various images and information are required to be provided so that various data may be provided to other users, since the image of target 1 shot at image shooting place 4 does not exist in the database 270.

That is, extension of an area occurs as illustrated in FIG. 8 in the case where the coordinates of image shooting place 4 do not belong to section 1, but the recommendation list provided by the server 200 includes the name of a target selected by the user of the mobile device 100. Extended section 1 may be an area within a closed surface formed by coordinates (x1, y1), (x2, y2), (x3, y3), and (x4, y4). Furthermore, the database 270 may update the database 270 according to extended section 1, after the extension of section 1.

FIGS. 9 to 12 are diagrams exemplarily illustrating a case in which new section generation occurs according to an embodiment of the inventive concept. As described above, in the case where a section to which the coordinates of an image shooting place belong is not stored in the database 270, and the recommendation list provided by the crowdsourcing module 230 does not include the name of a target, a new section may be generated. In FIGS. 9 to 12, the X-axis denotes longitude, and the Y-axis denotes latitude.

Referring to FIG. 9, it is assumed that a certain user has shot the image of target 1 at image shooting place 1. Since the database 270 does not store a section to which target 1 belongs nor any information about target 1, the coordinates (x1, y1) of image shooting place 1 may be section n+1 theoretically. However, practically, the coordinates of image shooting place 1 may be hardly considered to form section n+1, since information about target 1 is not retrieved from the database 270 unless another user shoots the image of target 1 exactly at image shooting place 1.

Referring to FIG. 10, it is assumed that another user has shot the image of target 1 at image shooting place 2 after the shooting by the certain user. Since image shooting place 1 is defined as section n+1 in the database 270, information about target 1 may not be retrieved.

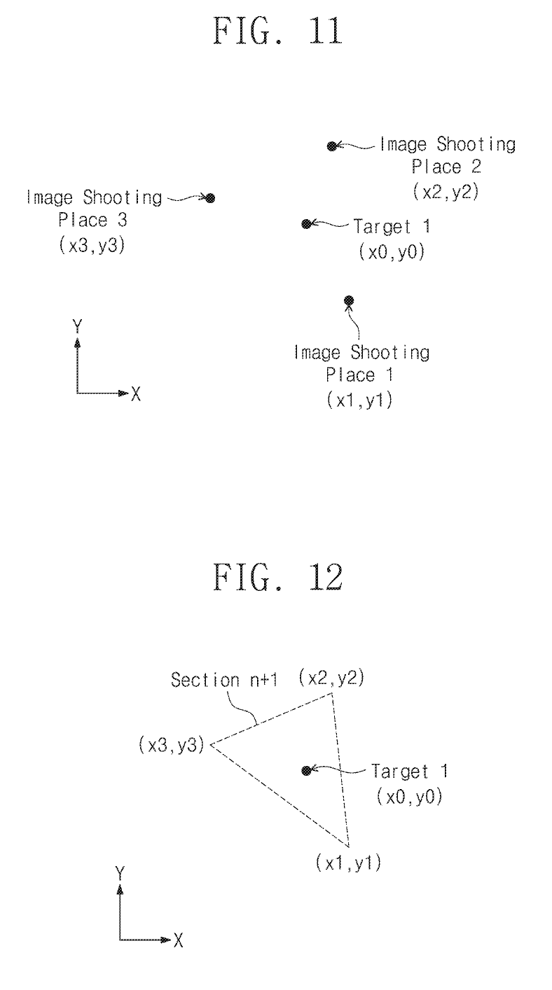

Referring to FIG. 11, it is assumed that still another user has shot the image of target 1 at image shooting place 3 after the shooting by the other user. However, in this case, as illustrated in FIG. 12, a closed surface formed by the coordinates of image shooting place 1, the coordinates of image shooting place 2, and the coordinates of image shooting place 3 may be generated. Therefore, the user who has shot the image of target 1 at image shooting place 3 may use information about target 1 of which the image has been shot at image shooting place 1 and information about target 1 of which the image has been shot at image shooting place 2.

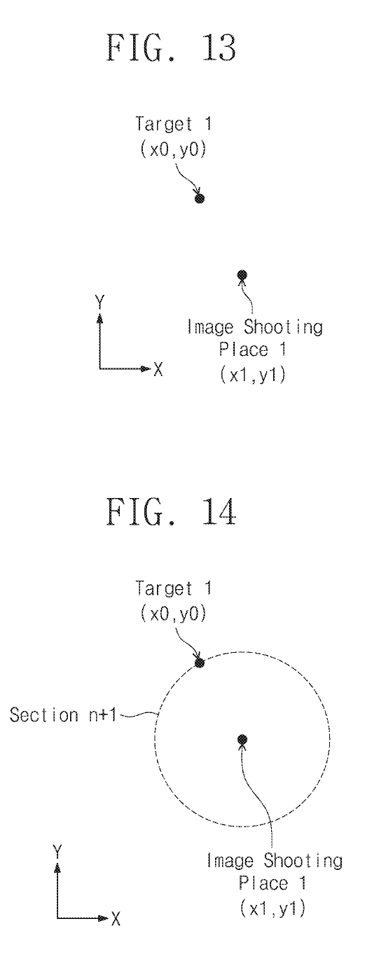

Described above is a process of forming a new section by virtue of multiple users' shooting images of a target. However, it is not necessarily required to shoot images of the same target at three different places to form a new section. Relevant detailed description will be provided with reference to FIGS. 13 to 15.

FIGS. 13 to 15 are diagrams exemplarily illustrating a case in which new section generation occurs according to an embodiment of the inventive concept. As described above, in the case where a section to which the coordinates of an image shooting place belong is not stored in the database 270, and the recommendation list provided by the crowdsourcing module 230 does not include the name of a target, a new section may be generated. In FIGS. 13 to 15, the X-axis denotes longitude, and the Y-axis denotes latitude.

It is assumed that the user of the mobile device 100 has shot the image of target 1 at image shooting place 1 as illustrated in FIG. 13. In this case, new section n+1 may be generated as illustrated in FIG. 14, although images of target 1 have not been shot at three different places. For example, as illustrated in FIG. 14, new section n+1 may be defined by an area within a circle centered at the coordinates of image shooting place 1 and having a radius equal to a distance between the coordinates of image shooting place 1 and the coordinates of target 1.

For example, if an image of a target is shot using a mobile device provided with a camera module which performs auto focusing with an infrared sensor, the distance between the coordinates of image shooting place 1 and the coordinates of target 1 may be measured. The distance between the image shooting place and the target may be approximately measured by using an auto-focusing function for focusing on the target by irradiating infrared light to the target and measuring a time taken for the infrared light to be reflected and return. Therefore, new section n+1 may be generated as illustrated in FIG. 14.

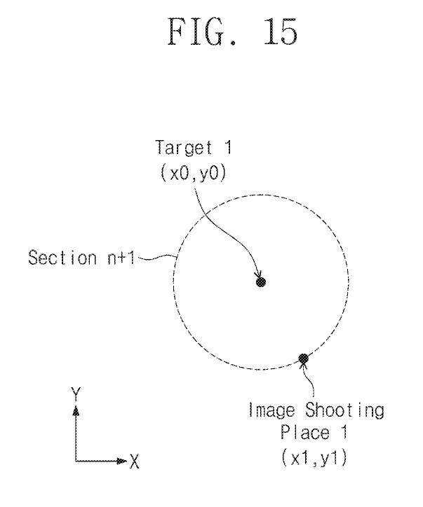

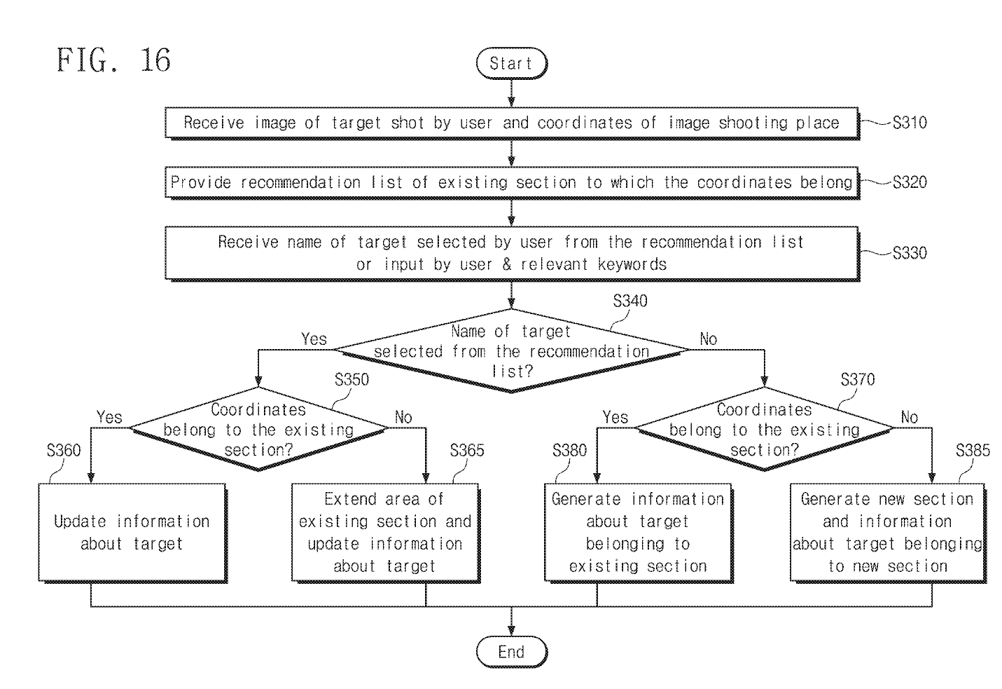

Alternatively, as illustrated in FIG. 15, new section n+1 may be defined by an area within a circle centered at the coordinates of target 1 and having a radius equal to the distance between the coordinates of target 1 and the coordinates of image shooting place 1.

According to the embodiment described above with reference to FIGS. 13 to 15, a new section may be generated by shooting an image only one time, even in the case where a section to which a target belongs is not defined in a database, and no information about the target is stored in the database.

FIG. 16 is a flowchart illustrating a method for constructing a place database according to an embodiment of the inventive concept. For example, operations described with reference to FIG. 16 may be performed by the server 200 including the crowdsourcing module 230 and the database 270 described above with reference to FIGS. 1 to 15.

In operation S310, an image of a target shot by the user of the mobile device 100 and the coordinates of an image shooting place may be received. For example, the coordinates of the image shooting place may be measured by a GPS module or the like at the same time as shooting the image, so as to be tagged to an image file of the target.

In operation S320, the recommendation list of an existing section to which the coordinates of the image shooting place belong may be provided to the user of the mobile device 100. Here, the section may represent a geographical area defined by a closed surface, and at least one target may belong to each section. That is, in the database, data on a plurality of targets may be classified and stored according to sections. The recommendation list may include names of a plurality of targets belonging to the existing section to which the coordinates of the image shooting place belong.

In operation S330, a target name selected from the recommendation list or input by the user may be received. Furthermore, relevant keywords related to the target may also be received. For example, if a name desired by the user of the mobile device 100 exists in the recommendation list provided by the server 200, the user may select the target name from the recommendation list. On the contrary, if the name desired by the user of the mobile device 100 does not exist in the recommendation list provided by the server 200, the user itself may input the target name.

The present operation may include transmitting tags for updating the database and receiving target-related keywords corresponding to the transmitted tags. For example, these operations may be performed by providing the tags to the user of the mobile device 100 via a user interface and receiving keywords input by the user, as described above with reference to FIG. 6.

In operation S340, it may be determined whether the target name received from the mobile device 100 has been selected from the recommendation list. According to a result of the determination, the process may proceed to different operations. If the target name received from the mobile device 100 has been selected from the recommendation list (YES), operation S350 is performed. However, if the target name received from the mobile device 100 has not been selected from the recommendation list (NO), operation S370 is performed.

In operation S350, it may be determined whether the coordinates of the image shooting place received from the mobile device 100 belong to any one of existing sections stored in the database. If the coordinates of the image shooting place belong to any one of the existing sections (YES), this case represents a case in which data on the target (e.g., target image, keyword, etc.) is required to be updated, but section area extension is not required. Therefore, operation S360 may be performed to update information about the target.

On the contrary, if the coordinates of the image shooting place belong to none of the existing sections (NO), this case represents a case in which data on the target (e.g., target image, keyword, etc.) is required to be updated, and section area extension is also required. Therefore, operation S365 may be performed to extend an area of an existing section and update information about the target. Since the section area extension is similar to that described above with reference to FIGS. 7 and 8, detailed descriptions are not provided.

Meanwhile, also in operation S370, it may be determined whether the coordinates of the image shooting place received from the mobile device 100 belong to any one of the existing sections stored in the database. If the coordinates of the image shooting place belong to any one of the existing sections (YES), this case represents a case in which data on the target (e.g., target image, keyword, etc.) is required to be newly generated. Therefore, operation S380 may be performed to generate information about a new target belonging to an existing section.

On the contrary, if the coordinates of the image shooting place belong to none of the existing sections (NO), this case represents a case in which data on the target (e.g., target image, keyword, etc.) is required to be newly generated, and a new section including the coordinates of the target is also required to be generated. Therefore, operation S385 may be performed to generate the new section and newly generate information about a new target belonging to the new section. Since the new section generation is similar to that described above with reference to FIGS. 9 to 15, detailed descriptions are not provided.

The method for constructing a database for a target by using image shooting coordinates received with an image of the target from a user of a mobile device has been described in detail with reference to FIG. 16. According to this embodiment of the inventive concept, the number of data may be gradually increased through image crowdsourcing based on users' participation. Furthermore, various services may be provided to users by gradually extending a section to which a target belongs and accumulating images of the target shot at various angles and keywords related thereto.

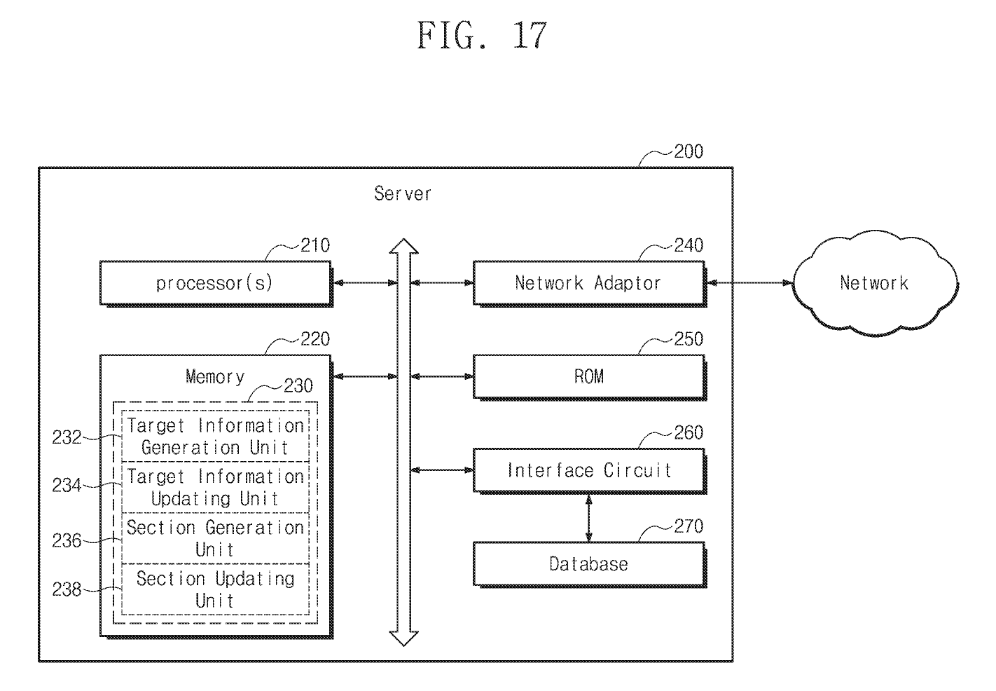

FIG. 17 is a diagram illustrating an example of implementation of the server 200 for constructing a place database according to an embodiment of the inventive concept. Referring to FIG. 17, the server 200 may include at least one processor 210, a memory 220, a network adaptor 240, a ROM 250, and an interface circuit 260.

The processor 210 may control overall operation of the server 200. For example, the processor 210 may be implemented in various forms such as a generic purpose processor, a microprocessor, an application specific integrated circuit (ASIC), an application processor (AP), etc.

Various software or firmware for driving the crowdsourcing module 230 may be loaded and run on the memory 220. For example, various software or firmware such as a target information generation unit 232, a target information updating unit 234, a section generation unit 236, and a section updating unit 238 may be loaded on the memory 220. Such software, firmware, or emulator may be run by the processor 210. For example, the memory 220 may include at least one of a dynamic random access memory (DRAM), a static random access memory (SRAM), a phase-change RAM (PRAM), or a cache memory.

The target information generation unit 232 may be run in the case of newly generating information about a target which belongs to an area of a section already generated in the database 270 but is not stored in the database 270. The target information updating unit 234 may be run in the case of updating information about a target which belongs to an area of a section already generated in the database 270 and is stored in the database 270. The section generation unit 236 may be run in the case of newly generating information about a target which does not belong to an area of a section already generated in the database 270 and is not stored in the database 270. The section updating unit 236 may be run when information about a target already stored in the database 270 is required to be updated, but the coordinates of the target are outside an area of an existing section. However, the above-mentioned software, firmware, or emulator is merely an example, and thus may be implemented in other various forms capable of performing the above- mentioned functions.

The network adaptor 240 may perform communication with the mobile device 100 (see FIG. 1) via a network. For example, an image file of a target and the coordinates of an image shooting place may be received from the mobile device 100 via the network adaptor 240. For example, the communication may be performed via a wireless local area network (WLAN), a wide area network (WAN), Wi-Fi, multi-hop networks, or a cellular network such as 3G, 4G, 5G, or long term evolution (LTE). However, an embodiment of the inventive concept is not limited thereto, and thus various means enabling the communication between the mobile device 100 and the server 200 may be used.

The ROM 250 may store various software, firmware, or the like required to operate the server 200 and the crowdsourcing module 230. For example, such software or firmware may be stored in the ROM 250 so as to be loaded on the memory 220, and may be run by the processor 210. However, an embodiment of the inventive concept is not limited thereto, and thus such software or firmware may be stored in a separate storage space provided in the database 270.

The interface circuit 260 may include various interfaces for data exchange with the database 270. For example, the interface circuit 260 may include various interfaces enabling uploading of image files or keywords via a network or downloading from the database 270 when retrieving data through a search service.

The database 270 may store various information (e.g., image files, keywords, etc.) about targets. The information about targets may be classified according to sections so as to be stored. The database 270 may include a nonvolatile memory such as a flash memory. However, the database 270 is not limited thereto, and thus may include a hard disk drive (HDD).

In the embodiment described above with reference to FIG. 17, the target information generation unit 232, the target information updating unit 234, the section generation unit 236, and the section updating unit 238 are described as software or firmware to be loaded and run on the memory 220. However, an embodiment of the inventive concept is not limited thereto, and thus such modules may be implemented as separate semiconductor chips.

According to an embodiment of the inventive concept, a method and system for constructing a place database using crowdsourcing may be provided.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A method for constructing a place database using data transmitted from a mobile device to a server, the method comprising:
receiving an image of a target shot by the mobile device and coordinates of an image shooting place of the target;
providing a recommendation list of a section to which the received coordinates belong;
receiving, from the mobile device, a name of the target selected or not selected from the recommendation list;
receiving keywords related to the target for constructing or updating the database; and
constructing or updating the database on the basis of the image and the keywords.

2. The method of claim 1, wherein the data are classified and stored in the database according to a section to which coordinates of the target or the received coordinates belong.

3. The method of claim 2, wherein the received coordinates are based on latitude and longitude, are measured by a GPS module provided to the mobile device, and are tagged to the image when the image of the target is shot.

4. The method of claim 1, wherein the name of the target received from the mobile device is selected by a user of the mobile device from the recommendation list or input by the user.

5. The method of claim 1, wherein the receiving the keywords comprises:
transmitting tags for constructing or updating the database; and
receiving keywords input by a user of the mobile device, the keywords corresponding to the tags, respectively.

6. The method of claim 5, further comprising:
determining whether the name of the target received from the mobile device is selected from the recommendation list; and
determining whether the received coordinates belong to an existing section present in the database.

7. The method of claim 6, wherein, in a case where the name of the target received from the mobile device is selected from the recommendation list and the received coordinates belong to the existing section present in the database, information about the target stored in the database is updated.

8. The method of claim 6, wherein, in a case where the name of the target received from the mobile device is selected from the recommendation list and the received coordinates do not belong to the existing section present in the database, extension of an area of the existing section is performed, and information about the target stored in the database is updated.

9. The method of claim 8, wherein the extension of the area of the existing section is performed so that the existing section and a closed surface formed by the received coordinates are included within an area of an extended section.

10. The method of claim 6, wherein, in a case where the name of the target received from the mobile device has not been selected from the recommendation list and the received coordinates belong to the existing section present in the database, information about the target belonging to the existing section is newly generated.

11. The method of claim 6, wherein, in a case where the name of the target received from the mobile device has not been selected from the recommendation list and the received coordinates do not belong to the existing section present in the database, a new section comprising the received coordinates and information about the target belonging to the new section are newly generated.

12. The method of claim 11, wherein the new section has an area within a closed surface formed by coordinates of at least three image shooting places of the target.

13. The method of claim 11, wherein the new section has an area within a circle centered at the received coordinates and having a radius equal to a distance between the received coordinates and coordinates of the target.

14. The method of claim 13, wherein the distance between the received coordinates and the coordinates of the target is measured using an auto-focusing function performed using an infrared sensor installed in the mobile device.

15. A server comprising:
a crowdsourcing module configured to receive an image of a target shot by a mobile device and coordinates of an image shooting place of the target, receive a name of the target selected or not selected from a recommendation list of a section to which the received coordinates belong, and receive keywords related to the target; and
a database in which the image and the keywords are classified and stored according to a section to which coordinates of the target or the received coordinate belong.

16. The server of claim 15, wherein the crowdsourcing module updates information about the target stored in the database in a case where the name of the target received from the mobile device is selected from the recommendation list and the received coordinates belong to an existing section present in the database.

17. The server of claim 15, wherein the crowdsourcing module extends an area of an existing section present in the database and updates information about the target stored in the database in a case where the name of the target received from the mobile device is selected from the recommendation list and the received coordinates do not belong to the existing section.

18. The server of claim 15, wherein the crowdsourcing module newly generates information about the target belonging to an existing section present in the database in a case where the name of the target received from the mobile device has not been selected from the recommendation list and the received coordinates belong to the existing section.

19. The server of claim 15, wherein the crowdsourcing module newly generates a new section comprising the received coordinates and information about the target belonging to the new section in a case where the name of the target received from the mobile device has not been selected from the recommendation list and the received coordinates do not belong to an existing section present in the database.

20. The server of claim 15, further comprising:
a memory configured to load the crowdsourcing module;
a processor configured to run the crowdsourcing module loaded on the memory; and
a network adaptor configured to communicate with the mobile device via a network.
